(19) United States
(12) Patent Application Publication
(10) Pub. No.: US 2010/0188606 A1
(43) Pub. Date: Jul. 29, 2010

(54) HIGH COLOR SATURATION DISPLAY AND COLOR ADJUSTING METHOD THEREOF

(76) Inventors: Chun-Chieh WANG, Hsin-Chu (TW); Chun-Liang Lin, Hsin-Chu (TW); Chen-Hsien Liao, Hsin-Chu (TW)

Correspondence Address: Muncy, Geissler, Olds & Lowe, PLLC, 4000 Legato Road, Suite 310, FAIRFAX, VA, 22033, US

(21) Appl. No.: 12/691,352

(22) Filed: Jan. 21, 2010

(30) Foreign Application Priority Data
Jan. 23, 2009 (TW) 098102975

(51) Int. Cl. G02F 1/13357; G02F 1/1335

(52) U.S. Cl. 349/62; 349/71

(57) ABSTRACT

A display device and a color adjusting method are provided. The display device includes a backlight source and color resists disposed above the backlight source for filtering the light from the backlight source. An intensity spectrum of the backlight source has several segments which includes a first segment having a peak value existing at a wavelength between 515 nm and 535 nm. The color resists have a peak transmittance, which is smaller than 75%, existing at a wavelength between 520 nm and 540 nm. In addition, the transmittance of the color resists is smaller than 0.05% at the wavelength of 730 nm. Since the wavelength ranges in the range mentioned above are correlated, the color resists are capable of adjusting the light from the backlight source to enhance the color saturation.

This application claims the priority based on a Taiwanese Patent Application No. 098102975, filed on Jan. 23, 2009, the disclosure of which is incorporated herein by reference in its entirety.

### BACKGROUND OF THE INVENTION

1. Field of the Invention

This invention relates to a display device and a color adjusting method thereof; more particularly, this invention relates to a display device with high color saturation and a color adjusting method thereof.

2. Description of the Prior Art

Display panels and the display devices that use display panels have become the mainstream for all kinds of display devices. For example, all kinds of panel display screens, home flat TVs, flat monitors of personal computers and laptop computers, and the display screens of mobile phones and digital cameras are all largely used in display panel products. As the market demand for LCD display devices has significantly grown, in order to suit the requirements of LCDs for the functions and the appearance, the backlight modules used by the LCD displays have become various.

Generally, white light LEDs are more often adopted as the light source of backlight modules. Conventionally, white LEDs adopt blue light LED chips to stimulate yellow green fluorescent powder to emit different light colors and create white light by mixing lights. However, the quality of the color saturation of the white light created in this way, particularly with the saturation of the green light, is still a certain distance away from that of the light created by cathode ray tubes. Recently, some white light LEDs have adopted blue light LED chips and red and green fluorescent powders, which create white light through mixing light. The color saturation of the white light created by this kind of arrangement is slightly improved compared to the white light created by incorporating yellow green fluorescent powders, but the requirements on color saturation still can not be reached.

### SUMMARY OF THE INVENTION

An objective of this invention is to provide a display device having better color saturation.

Another objective of this invention is to provide a color adjusting method used by display devices, which can improve the color saturation of the display device.

The display device includes a backlight module and a display panel. The display panel is disposed on the backlight module, and the backlight module includes a backlight source and an optical film. The display panel includes a first substrate, a second substrate, and a liquid crystal layer. The first substrate is preferably a color filter substrate with color filter layer disposed thereon. The second substrate is preferably a thin film transistor substrate with thin film transistor circuit disposed thereon. The liquid crystal layer is sandwiched between the first substrate and the second substrate. By controlling the thin film transistor circuit to align liquid crystals in the liquid crystal layer in cooperation with the color filter layer having different transmittances for different wavelengths, images can be created. In this embodiment, the color filter layer is disposed on the inner surface of the color filter substrate and includes a plurality of color resists. When the second substrate is a substrate including thin film transistors and the color filter layer, the plurality of color resists can be disposed on the same side or different sides of the second substrate with respect to the thin film transistor circuit. When the light of the backlight source transmits through the color filter layer, the light with predetermined wavelengths will be allowed to go through, and the light with other wavelengths will be blocked, and then through the rotation angles of the liquid crystals, the image can be displayed.

The backlight source has an intensity spectrum including a plurality of segments, and each segment has a peak value (i.e. local maximum value). The peak value of a first segment exists at a wavelength between 515 nm and 535 nm. The green resists of the color filter layer have a transmittance spectrum, and the transmittance spectrum is at least overlapped with the first segment in the wavelength range between 520 nm and 535 nm. Moreover, the green resists have a peak transmittance at the wavelength between 520 nm and 540 nm. The peak transmittance is smaller than 75%. Furthermore, the transmittance of the green resists is smaller than 0.05% at the wavelength of 730 mm. Since the wavelength range of the transmittance spectrum of the green resists is correlated with the wavelength range of the first segment having the peak value in the intensity spectrum of the backlight source, the green resists are capable of adjusting the light from the backlight source to enhance the color saturation.

The color adjusting method of the display device includes the following steps: adjusting the intensity spectrum of the backlight source, so that a first segment of the intensity spectrum has a peak value or a local peak value at a wavelength between 515 nm and 535 nm; and forming green resists on the backlight source to filter light from the backlight source. Moreover, the transmittance of the green resists is controlled to be smaller than 0.05% at the wavelength of 730 nm, and a peak transmittance smaller than 75% exists at the wavelength between 520 nm and 540 nm.

### BRIEF DESCRIPTION OF THE DRAWINGS

FIG. 1 schematically illustrates an embodiment of the display device of this invention;

FIG. 2 schematically illustrates an embodiment of the backlight source;

FIG. 3 schematically illustrates an embodiment of the backlight source intensity spectrum;

FIG. 4 is a schematic view of color resist transmittance spectrum incorporated with relative intensity spectrum illustrated by FIG. 3;

FIG. 5A is an embodiment of the color resist disposition;

FIG. 5B is another embodiment of the color resist disposition;

FIG. 6 is a flow chart of an embodiment of a color adjusting method of the display device of this invention; and

FIG. 7 is a flow chart of another embodiment of the color adjusting method.

### DETAILED DESCRIPTION OF THE PREFERRED EMBODIMENT

This invention provides a display device and the color adjusting method thereof. Take an embodiment as an example, the display device of this invention includes a liquid crystal display device, such as LCD televisions, LCD monitors of personal computers and laptop computers, and LCD screens of mobile phones and digital cameras.

As illustrated by FIG. 1, the display device of this invention preferably includes a backlight module 100 and a display panel 200. In this embodiment, the backlight module 100 adopts the design of direct type backlight module; however, in other embodiments, the backlight module 100 can also include a light guide to employ the design of edge type backlight module. Display panel 200 is disposed on the backlight module 100 and provided for receiving light emitted from the backlight module 100, so as to create images on the display panel 200. The display panel 200 preferably includes a first substrate 210, a second substrate 230, and a liquid crystal layer 250. The liquid crystal layer is sandwiched between the first substrate 210 and the second substrate 230, and electrodes on the first substrate 210 and the second substrate 230 are used to control the behavior of the liquid crystal cells.

When the first substrate 210 is a color filter substrate, the color filter layer includes a plurality of color resists 300 and is disposed on the inner side of the first substrate 210; however, in other embodiments, the color filter layer can be disposed on the second substrate 230 or above the backlight source 103 of the backlight module 100. In this embodiment, after the light of the back light module 100 passes through the liquid crystal layer 250, the light will go through a plurality of color resists 300 of the first substrate 210. Different color resists 300 are selective to light with different wavelengths; therefore, the color resists 300 will allow light with predetermined wavelengths to pass through and block light with other wavelengths, such that the display panel 200 displays different images. In this embodiment, the color resists 300 of the color filter layer preferably include red, green, and blue resists, and the thickness thereof is preferably between 1.4 μm and 2.5 μm to suit the requirements of manufacturing process and other elements. Of course, the color filter layer can include other color resists, such as yellow and magenta.

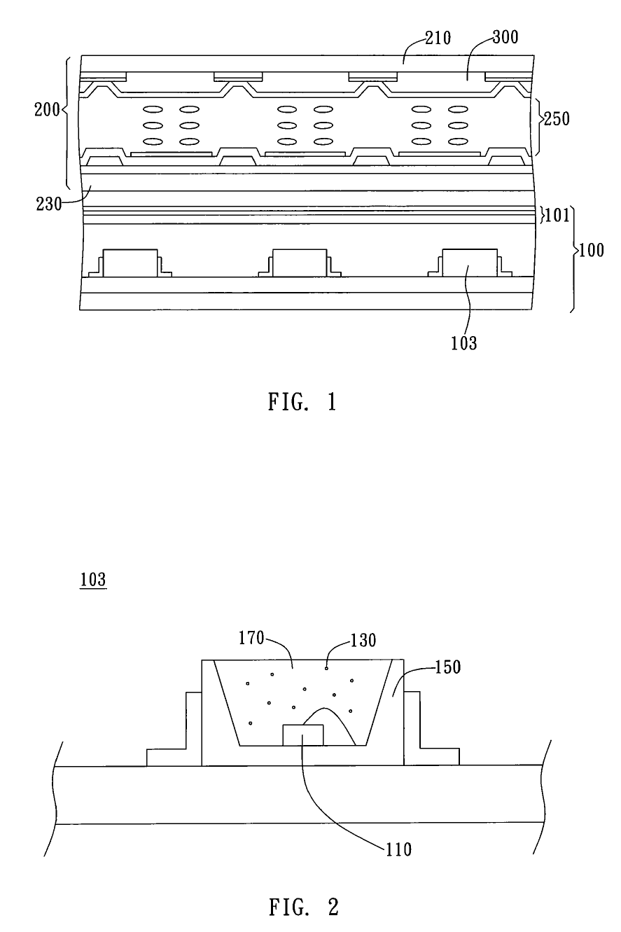

The backlight source 103 of the backlight module 100 preferably consists of white light LEDs. In this embodiment, the backlight module 100 further includes optical films 101, such as a diffuser plate, a diffuser film, a brightness enhancement film, and a polarization film, disposed on the backlight source 103. The backlight source 100 can also include a reflective plate and other optical elements disposed correspondingly to the backlight source 103 to improve the brightness and evenness of the backlight module 100. As in the embodiment illustrated by FIG. 2, the white light LED includes an active light source 110 and a passive light source 130. The active light source 110 can emit light after signals are provided, and the passive light source 130 is excited by the active light source 110 to generate another color of light. In this embodiment, the active light source 110 is preferably blue diode chips, and the passive light source 130 is non-blue fluorescent powders, particularly the fluorescent powder with wavelengths longer than blue diode chips. When the blue light is emitted by blue LED chips, other different color lights will be excited to generate white light. In the preferred embodiment, the blue light emitting diode chips are used with red and green fluorescent powders; however, in other embodiments, the blue light emitting diode chips can also be used with yellow green fluorescent powders. In this embodiment, the fluorescent powders are mixed in the transparent body 170 of the bowl cup 150 of the white light LEDs. In other embodiments, fluorescent powders can be disposed on part of the light exiting surface of the blue diode chips by coating or adhering.

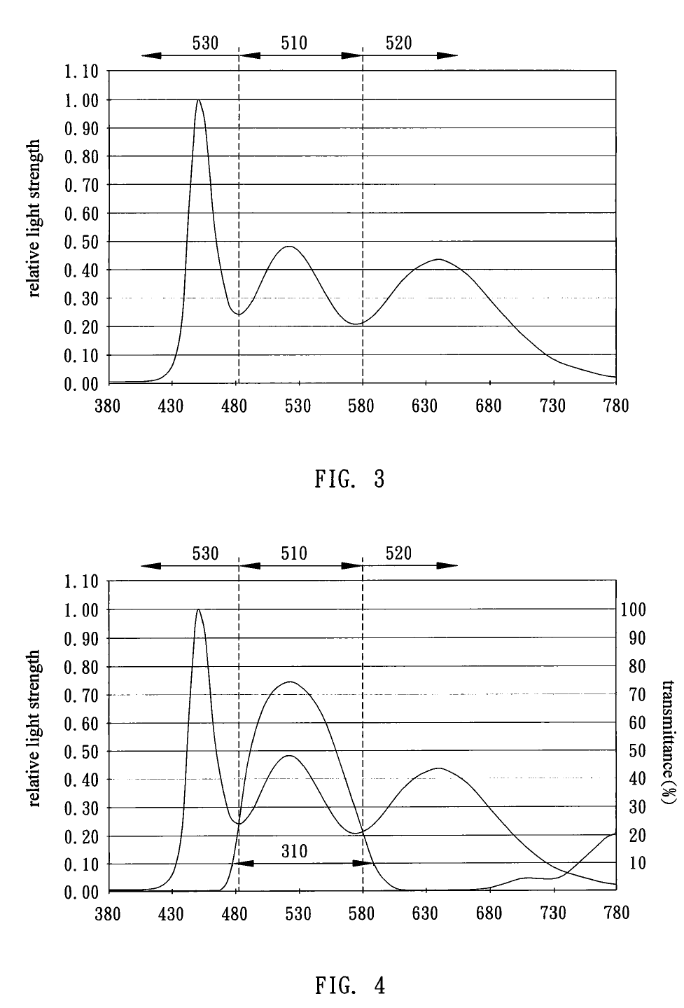

FIG. 3 is the intensity spectrum of the backlight source of this embodiment. As illustrated by FIG. 3, when the backlight source 103 is formed by blue LED chips and red and green fluorescent powders, the intensity spectrum includes a plurality of segments. Moreover, each segment has a peak value that is the local maximum value. In order to clearly illustrate, the longitudinal axis in FIG. 3 is represented by relative light intensity. In this embodiment, on the spectrum, there includes a first segment 510 in the middle, a second segment 520 on the right, and a third segment 530 on the left. The first segment 510 is close to the green light region, and the wavelength is preferably between 490 nm and 580 nm. The second segment 520 is close to the red light region, and the wavelength is preferably larger than 580 nm. The third segment 530 is close to the blue light region, and the wavelength is preferably smaller than 490 nm. As illustrated by FIG. 2, this embodiment adopts blue LED chip to be the active light source 110 to generate blue light and then excites the passive light source 130 formed by fluorescent powders. Therefore, the peak value in the third segment 530 is preferably larger than the peak values in the first segment 510 and the second segment 520. Moreover, in this embodiment, the peak value in the first segment 510 exists at the wavelength between 515 nm and 535 nm; and the peak value in the second segment 520 exists at the wavelength larger than 630 nm.

Comparing to FIG. 3, the additional curve in FIG. 4 is the transmittance spectrum of the green resist of the color filter layer. As illustrated by FIG. 4, the longitudinal axis on the right hand side in FIG. 4 represents the transmittance of the color resists. The transmittance spectrum of the green resist of the color filter layer includes a transmittance segment 310, and the transmittance segment 310 is at least overlapped with the first segment 510 in the area between 520 nm and 535 nm. In this embodiment, transmittance segment 310 is between 480 nm and 600 nm. Moreover, the green resist of the color filter layer has a peak transmittance in the transmittance segment 310. The peak transmittance preferably exists at the wavelength between 520nm and 540 nm, and the peak transmittance is smaller than 75%. Since the wavelength range for the transmittance segment is correlated with the intensity spectrum of the backlight module 100 which has the wavelength range between 515 nm and 535 nm, the green resists of the color filter layer are capable of adjusting the light from the backlight source 100 to enhance the color saturation. In the preferred embodiment, if the light that goes through the green resists of the color filter layer is analyzed and the coordination of the green light in the color space is given by (Gx, Gy), Gx is preferably between 0.190 and 0.230, and Gy can be larger than or equal to 0.685.

As illustrated by FIG. 4, in the transmittance spectrum of the green resists of the color filter layer, when the wavelength corresponds to 730 nm or larger than 730 nm, the transmittance thereof is smaller than 0.05%. Moreover, in this embodiment, apart from the wavelength that is corresponding to 730 nm, when the wavelength is between the wavelength range corresponding to the second segment 520, the transmittance thereof is smaller than 0.05%. With such a characteristic of the green resists of the color filter layer, the negative effects on the color caused by other color lights in the green light created by green pixels can be suppressed.

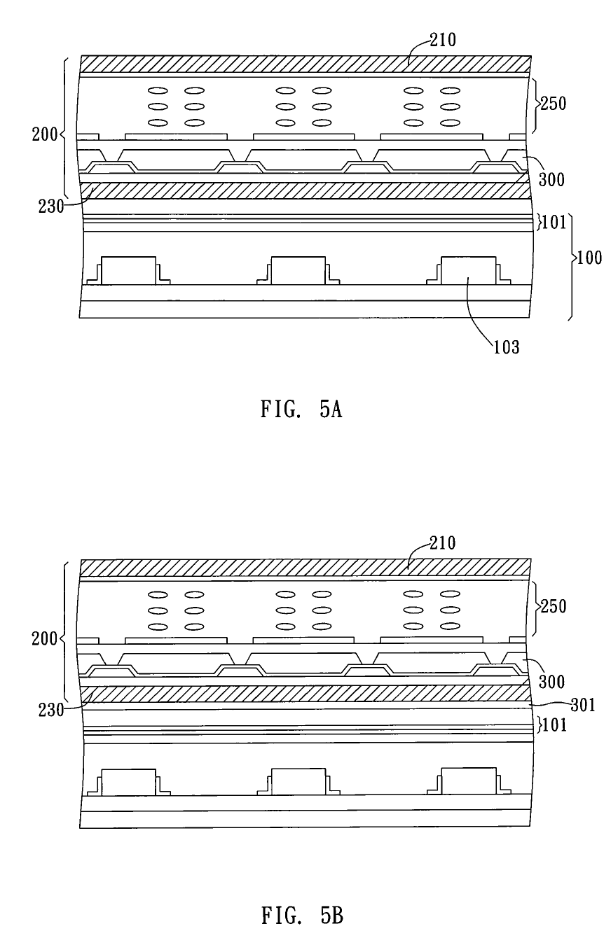

FIG. 5A illustrates another embodiment of the disposition of the color filter layer. In this embodiment, the color filter layer and the thin film transistor circuit 231 are both disposed on the inner side of the second substrate 230; that is, the side that faces the first substrate 210. However, in other embodiments, other dispositions are possible. Moreover, in the embodiment illustrated by FIG. 5B, apart from the color filter layer, a layer of color resist 301 can be disposed on the outer side of the second substrate 230, which is opposite to the inner side. The forming method of the color filter layer includes deposition process, lithography process, coating process, and other processes that can form color resists 300.

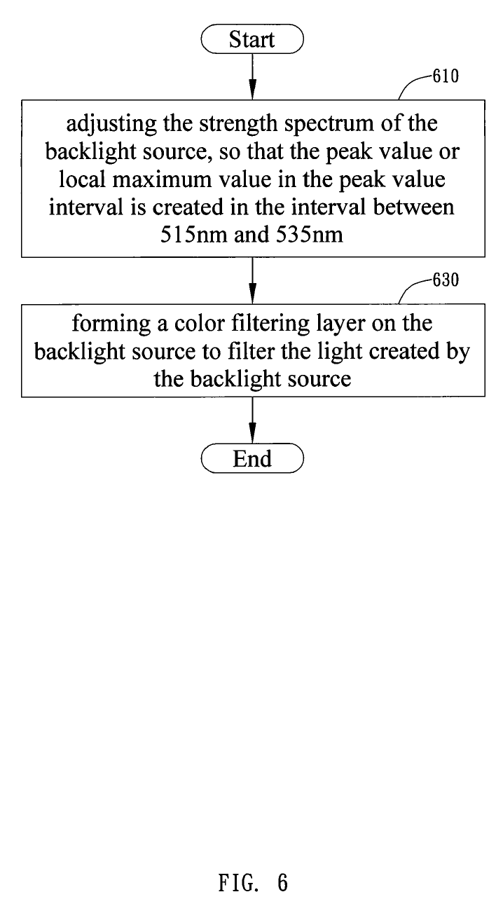

FIG. 6 illustrates a flow chart of a color adjusting method of the display device of this invention. Step 610 includes adjusting the intensity spectrum of the backlight source, so that the peak value or local maximum value in one segment exists at the wavelength between 515 nm and 535 nm. This step is preferably achieved by adjusting the relationship between the active light source and the passive light source of the backlight source. For example, the percentage, material, and types of the fluorescent powders used as the passive light source can be modified to achieve this adjustment. Furthermore, the selection of backlight sources that meet the requirements above can be performed to achieve this adjustment.

Step 630 includes forming a color filter layer on the backlight source to filter the light from the backlight source. Such a step can further control the transmittance of the green resists of the color filter to be smaller than 0.05% at the wavelength equal to 730 nm or larger than 730 nm, and a peak transmittance smaller than 75% exists at the wavelength between 520 nm and 540 nm. This step can be preferably achieved by choosing the material and thickness of the resists to achieve the transmittance characteristic stated above. Moreover, this step can form the color filter layer on any side of the display substrate or circuit substrate through application, deposition, lithography, coating, or other processes. With such a design, since the green resists are capable of adjusting the light from the backlight source, the display device can generate more pure green light to improve the color saturation.

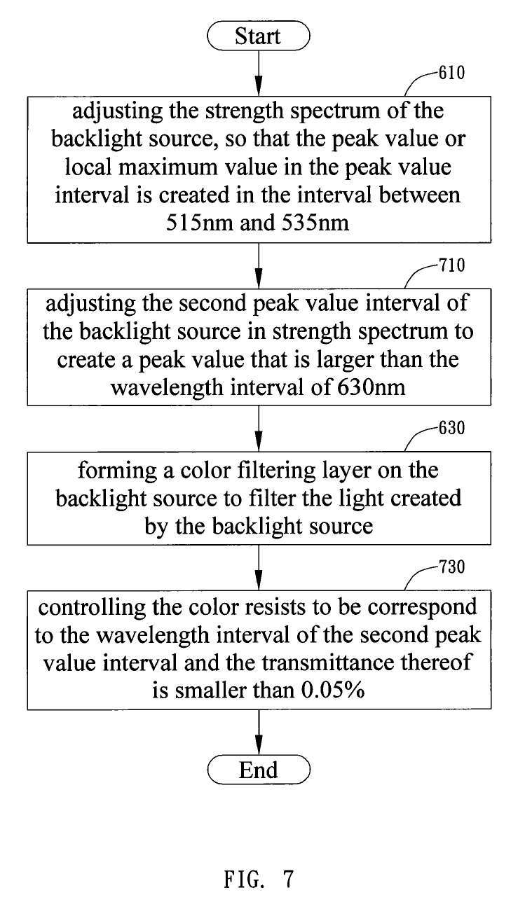

In the embodiment illustrated by FIG. 7, apart from step 610 and step 630 included in FIG. 6, the method can further include step 710 to adjust a second segment in the intensity spectrum of the backlight source to create a peak value at the wavelength larger than 630 nm. The peak value herein preferably includes the local maximum value. The wavelength range of the second segment is larger than that of the first segment; that is, the second segment is distributed closer to the red light region. In this embodiment, the method can further include step 730 of controlling the transmittance of the green resists at the wavelength corresponding to the wavelength range of the second segment to be smaller than 0.05%. By adjusting the transmittance of the green resists, the negative effects on the color caused by other color lights in the green light created by green pixels can be suppressed.

This invention has been described with the relevant embodiments above, however, the embodiments above are only exemplary. What needs to be pointed out is that the embodiments disclosed do not limit the scope of this invention. In contrast, the modifications and equivalents included in the spirit and scope of the claims are all included in the scope of this invention.

What is claimed is:

1. A display device, comprising:
a backlight source having an intensity spectrum including a plurality of segments, wherein a first peak value of a first segment of the plurality of segments exists at a wavelength between 515 nm and 535 nm; and
a color resist, formed on the backlight source to filter light from the backlight source, and a transmittance of the color resist is smaller than 0.05% at the wavelength of 730 nm;
wherein the color resist has a peak transmittance at a wavelength between 520 nm and 540 nm, and the peak transmittance is smaller than 75%.

2. The display device of claim 1, wherein the plurality of segments include a second segment distributed over a wavelength range larger than that of the first segment, and the second segment has a peak value at a wavelength larger than 630 nm.

3. The display device of claim 2, wherein the transmittance of the color resist is smaller than 0.05% in the wavelength range of the second segment.

4. The display device of claim 1, wherein the backlight source comprises:
an active light source; and
at least one passive light source, wherein the passive light source is excited by the active light source to create light,
wherein the plurality of segments in the intensity spectrum correspond to light generated by the active light source and the passive light source, and the first segment corresponds to the light generated by the passive light source.

5. The display device of claim 4, wherein the active light source includes a blue LED chip, and the passive light source includes a fluorescent powder.

6. The display device of claim 1, further comprising a display panel, the display panel having a first substrate and a second substrate, wherein the color resist is formed on an inner side of the first substrate.

7. The display device of claim 6, wherein the thickness of the color resist ranges from 1.4 μm to 2.5 μm.

8. A display device, comprising a backlight module and a display panel disposed on the backlight module,
wherein the backlight module includes a backlight source having an intensity spectrum, the intensity spectrum having a plurality of segments including a first segment;
the display panel includes a color resist formed on the backlight source to filter light from the backlight source, a transmittance of the color resist at the wavelength of 730 nm is smaller than 0.05%; and
the color resist has a transmittance spectrum is overlapped with the first segment at least between the wavelength of 520 nm and 535 nm.

9. The display device of claim 8, wherein the plurality of segments includes a second segment distributed over a wavelength range larger than that of the first segment, and the second segment has a peak value at a wavelength larger than 630 nm.

10. The display device of claim 9, wherein the transmittance of the color resist is smaller than 0.05% in the wavelength range of the second segment.

11. The display device of claim 10, wherein the first segment has a peak value at a wavelength between 515 nm and 535 nm.

12. The display device of claim 8, wherein the transmittance spectrum has a peak transmittance at a wavelength between 520 nm and 540 nm.

13. A color adjusting method of a display device, comprising:
adjusting an intensity spectrum of a backlight source, such that a first segment of the intensity spectrum has a peak value at a wavelength between 515 nm and 535 nm; and
forming a color resist on the backlight source to filter light from the backlight source, such that a transmittance of the color resist at the wavelength of 730 nm is smaller than 0.05%, and the color resist has a peak transmittance smaller than 75% at a wavelength between 520 nm and 540 nm.

14. The adjusting method of claim 13, further comprising enabling a second segment of the plurality of segments to have a peak value at a wavelength larger than 630 nm, and the second segment is distributed over a wavelength range larger than that of the first segment.

15. The adjusting method of claim 14, wherein the step of forming the color resist includes controlling the transmittance of the color resist to be smaller than 0.05% in the wavelength range of the second segment.
